(19) United States
(12) Patent Application Publication
(10) Pub. No.: US 2024/0116290 A1
(43) Pub. Date: Apr. 11, 2024

(54) COATING DEVICE, AND METHOD INVOLVING AN EMBOSSING STATION AND A PRINTING STATION

(71) Applicant: LEONHARD KURZ Stiftung & Co. KG, Fürth (DE)

(72) Inventors: Peter Petersen, Brackenheim (DE); Kurt Maier, Ellhofen (DE)

(21) Appl. No.: 17/767,677

(22) PCT Filed: Oct. 5, 2020
(86) PCT No.: PCT/EP2020/077826

§ 371 Date: Apr. 8, 2022

(30) Foreign Application Priority Data
Oct. 10, 2019 (DE) 10 2019 127 325.0

(51) Int. Cl. B41J 3/54; B41F 17/00

(52) U.S. Cl. CPC B41J 3/546; B41F 17/001

(57) ABSTRACT

A coating device for coating a base body, as well as a method. The coating device has at least one holding device for fixing a base body, at least one stamping station and at least one printing station for applying one or more printed layers to at least one partial area of a first surface of the base body and/or to at least one partial area of one or more film elements stamped on the base body and/or to at least one partial area of one or more further printed layers applied to the base body, and in that the stamping station has one or more stamping units for stamping one or more film elements on at least one partial area of a first surface of the base body and/or on at least one partial area of one or more further film elements stamped on the base body and/or on at least one partial area of one or more printed layers applied to the base body.

The invention relates to a coating device for coating a base body, as well as a method.

It is known to stamp or coat a transfer ply of a hot-stamping film onto a body for decoration. As described for example in DE 102012109315 A1, such a stamping device has a retaining device, in which the workpiece to be stamped or to be coated is clamped, as stamping receiver. Further, a stamping tool is provided, which presses a hot-stamping film against the surfaces of the workpiece to be decorated, wherein the stamping pressure here is built up between stamping receiver and stamping tool.

The object of the invention is now to specify a coating device for coating a base body, as well as a method, which improves the production of such a base body and reduces the production costs.

The invention is achieved by a coating device for coating a base body, in which the coating device has at least one holding device for fixing a base body, at least one stamping station and at least one printing station for applying one or more printed layers to at least one partial area of a first surface of the base body and/or to at least one partial area of one or more film elements stamped on the base body and/or to at least one partial area of one or more further printed layers applied to the base body, and in that the stamping station has one or more stamping units for stamping one or more film elements on at least one partial area of a first surface of the base body and/or on at least one partial area of one or more further film elements stamped on the base body and/or on at least one partial area of one or more printed layers applied to the base body.

This object is further achieved by a method for coating a base body, in particular with a previously described coating device, wherein, in the method, in particular in the following sequence, the following steps are carried out:
a) fixing the base body in a holding device,
b) stamping, in particular in a stamping station of the coating device, one or more film elements on at least one partial area of a first surface of the base body and/or on at least one partial area of one or more further film elements stamped on the base body and/or on at least one partial area of one or more printed layers applied to the base body, wherein the base body remains in the holding device,
c) applying, in particular in a printing station of the coating device, one or more printed layers to at least one partial area of a first surface of the base body and/or to at least one partial area of one or more film elements stamped on the base body and/or to at least one partial area of one or more further printed layers applied to the base body, wherein the base body remains in the holding device,
d) removing the coated base body from the holding device.

Through the invention, it is now possible to improve the possibilities of coating a base body and in particular to increase the variety of functions and/or the variety of designs. Through the coating of the base body, which is fixed in the holding device in a positive-locking and/or a non-positive-locking manner, by means of hot stamping and subsequent printing or in the reverse order by means of printing and subsequent hot stamping, a variety coatings can be carried out, which until now have only been performed in operations that are completely separate in particular in terms of time and space.

Advantageous embodiment examples of the invention are described in the dependent claims.

The base body is preferably a rigid body which in particular has at least one surface that is curved, even and/or uneven in areas.

It is in particular possible for the base body and/or a surface of the base body, in particular the surface of the base body to be coated, to be substantially flat, in particular two-dimensionally even, or 2.5-D deformed or three-dimensionally deformed.

The base body preferably comprises a component, in particular a vehicle part, a housing part, a cockpit component and/or a bodywork part, an injection-molded part, a 3D-printed part and/or a component produced by means of cutting and/or non-cutting production methods.

It is furthermore also provided in particular that the method comprises the following step, in particular wherein the step is performed before step a):
producing the base body by means of injection molding and/or 3D printing and/or cutting and/or non-cutting production methods.

Advantageously, the base body comprises a plastic material, which comprises a thermoplastic, in particular an impact-resistant thermoplastic. Further, the plastic material consists in particular of polyethylene (PE), polycarbonate (PC), polypropylene (PP), polystyrene (PS), polybutadiene, polynitriles, polyesters, polyurethanes, polymethacrylates, polyacrylates, polyamides, polyethylene terephthalate (PET), polybutylene terephthalate (PBT), preferably acrylonitrile butadiene styrene (ABS), acrylonitrile styrene acrylate (ASA), ABS-PC, PET-PC, PBT-PC, PC-PBT and/or ASA-PC and/or copolymers or mixtures thereof. It is also possible for the plastic material also to contain inorganic or organic fillers, preferably SiO₂, Al₂O₃, TiO₂, clay minerals, silicates, zeolites, glass fibers, carbon fibers, glass beads, organic fibers or mixtures thereof. Here, the fillers are added in particular to the plastic material in order to further increase the stability of the base body. Further, these fillers can reduce the proportion of polymeric materials and thus lower the production costs and/or the weight of the component. It is also possible for the plastic material also to contain inorganic or organic auxiliary substances which in particular improve the processability of the plastic material.

It is also possible for the material of the base body to comprise steel, copper, brass and/or other metallic materials and/or alloys. It is also possible for the material of the base body to comprise glass and/or wood.

It is in particular provided that, depending on the geometry and material of the base body, different holding devices are used which in particular are individually matched to the respective base body, are preferably matched in such a way that the holding devices fix the respective base body in a positive-locking and/or a non-positive-locking manner. It is provided that the clamping force of the holding device is chosen such that a distortion and/or a deformation of the base body due to the clamping force is ruled out.

The base body preferably remains in the holding device in a positive-locking and/or a non-positive-locking manner during all method steps. For one thing, a correspondingly high stamping and printing quality is hereby also ensured for the further stamping and printing steps and, for another, a particularly good registration of the stamped further film elements or the applied further printed layers, and thus the product quality, is also further considerably improved, and waste is correspondingly reduced.

By register or registration, or register accuracy or register precision or registration accuracy or positional accuracy, is meant in particular a positional accuracy of two or more elements and/or layers relative to each other. The register accuracy is preferably to range within a predefined tolerance and preferably be as high as possible. At the same time, the register accuracy of several elements and/or layers relative to each other is in particular an important feature in order to increase the process reliability. The positionally accurate positioning is effected in particular by means of sensory, preferably optically detectable registration marks or the position markings. In particular, these registration marks or position markings either represent special separate elements or areas or layers or are themselves part of the elements or areas or layers to be positioned.

It is furthermore also preferably provided that, during the stamping, the one or more film elements of the one or more film elements are stamped register-accurate relative to the one or more further film elements, in particular wherein one or more register marks of the optical features of the one or more further film elements and/or of the holding device are detected and used to control the stamping.

It is further in particular provided that the holding device can be opened and/or closed mechanically and/or hydraulically and/or pneumatically and/or electrically and/or by hand.

It is furthermore also possible for the method to comprise the following step, in particular wherein the step is performed before step a):
delivering and/or arranging the base body in the holding device.

The delivering and/or arranging of the base body is preferably effected by human hand, by a conveying device which leads to the holding device, and/or completely automated, for example by a robot.

It is preferably provided that the coating device has at least one movably mounted mold carrier, in particular a vertically or horizontally arranged rotary plate or sliding table, in particular with a linear drive. In particular, at least one holding device is arranged on it. The at least one holding device, in particular together with the fixed base body, can preferably be moved by means of the mold carrier at least between the at least one stamping station and/or the at least one printing station and/or the at least one pretreating station and/or the at least one checking station and/or the at least one cleaning station.

Furthermore, it is preferably possible for the coating device to have a number n stations, in particular the at least one stamping station, the at least one pretreating station, the at least one cleaning station and/or the at least one printing station, and for at least n holding devices to be arranged on the at least one mold carrier.

It is also possible for the coating device to have at least one adjusting device for moving the holding device and/or the at least one holding device arranged on the at least one common mold carrier between the stations of the coating device.

Here, it is preferably possible for one or more holding devices to be mounted on the at least one mold carrier and for them to be moved together with the at least one mold carrier by means of the adjusting device.

Further, it is in particular provided that the at least one adjusting device comprises at least one servo drive and/or at least one hydraulic drive and/or at least one pneumatic drive and/or at least one electric drive.

Further preferably, the adjusting device comprises one or more linear drives, in particular one or more high-precision linear drives, which in particular allow the at least one mold carrier to move in one spatial direction, preferably in two spatial directions, further preferably in three spatial directions. As a result, the individual work steps can be carried out positionally accurately and the manufacturing quality as well as the product quality is improved.

It is in particular provided that the linear drive has a rotary drive which converts a rotary movement into a linear, translational movement via a gear mechanism, in particular a shaft. It is also possible for the linear drive to comprise a linear direct drive or linear motor with which a linear, translational propulsion is possible directly, in particular via magnetic fields. A linear drive with a gear mechanism or shaft has a positioning accuracy of +/−50 μm or less, preferably of +/−30 μm or less. A linear direct drive or linear motor has a positioning accuracy of +/−10 μm or less, preferably of +/−5 μm or less, by which is meant here a high-precision linear drive. The high positioning accuracy of a high-precision linear drive can be achieved using an incremental or absolute direct measuring system on the linear drive, wherein the direct measuring system is coupled directly to the drive components of the linear drive and operates with reference to measuring dials (with or without prior calibration).

Further, it is in particular provided that the coating device has at least one process-control device, which actuates the adjusting device in particular such that the one or more holding devices are delivered cyclically in a predefined sequence to two or more stations of the coating device, in particular in a sequence: stamping station-printing station, printing station-stamping station, pretreating station-stamping station-printing station, stamping station-pretreating station-printing station, pretreating station-stamping station-pretreating station-printing station. Advantageously, the process-control device comprises one or more microprocessors, peripheral components for controlling the one or more stamping stations, the one or more printing stations, the one or more pretreating stations, the one or more UV-irradiation units (UV=electromagnetic radiation in the ultraviolet spectral range) and/or the one or more IR-irradiation units (IR=electromagnetic radiation in the infrared spectral range), the one or more film feed units and the at least one adjusting device, as well as corresponding software components.

In particular, it is possible here for the one or more holding devices to be delivered to a station multiple times.

For example, it is possible for steps b) and c) to be carried out once or multiple times and/or to be carried out in any desired order. It is further preferred for the cycle times of steps b) and c) to be in each case between 1 s and 300 s, preferably between 5 s and 120 s, in particular between 20 s and 30 s.

Preferably, it is further possible for the at least one mold carrier, on which the at least one holding device is arranged, in particular together with the fixed base body, before step b) to be moved into a stamping position for carrying out step b) and/or before step c) to be moved into a printing position for carrying out step c).

It is furthermore expedient for the stamping station to have at least one turret, which is preferably mounted rotatable about at least one axis and is movable in a translational manner along at least one axis, in particular wherein the turret comprises one or more stamping die receivers which receive one or more stamping dies. Through the arrangement of several stamping dies in one turret it is possible to stamp various motifs by means of different stamping dies and at the same time to guarantee a short cycle time.

It is in particular expedient for the one or more stamping dies to be replaceably mounted on the one or more stamping die receivers of the at least one turret, preferably wherein each stamping die receiver in each case has a quick-change system for tool-free replacement of the stamping dies, preferably wherein the quick-change system has a dovetail bracket and/or a clamping lever for replacing the stamping dies.

It is further possible for the quick-change system to comprise a die holding plate which has thermal insulation and/or a quick-release connector, in particular at least one clamping lever and/or at least one dovetail bracket, and/or a direct heater integrated in the die holding plate. The thermal insulation preferably ensures that the heat forming during the stamping process is not transferred to other components of the coating device. The further advantage results in particular that the coating device set-up times are considerably reduced by the quick-change system.

Further, it is preferably possible for the one or more stamping die receivers and the one or more stamping dies to be encoded, preferably to be encoded by means of RFID chips. The advantage preferably results that the coating device thereby recognizes the inserted stamping die and, for example, process parameters specifically matched for it are provided from a database of the arithmetic unit of the coating device.

Further, it is preferably provided that the one or more stamping dies not mounted on the turret are temporarily mounted in a bracket of the coating device for preheating. The heating range preferably lies between 0° C. and 300° C., in particular between 80° C. and 250° C.

The advantage thereby preferably results that, when the stamping dies are replaced, the newly mounted stamping die is heated up much more quickly and thus the downtime of the coating device is also shortened as the manufacturing process can be resumed earlier.

In particular, it is expedient for the one or more stamping dies each to have at least one direct heater for rapidly heating the stamping die. Here, the one or more stamping dies in particular have heating wires and the advantage of energy saving preferably results. It is preferably provided that the heating range of the one or more stamping dies lies between 0° C. and 300° C., in particular lies between 80° C. and 250° C.

It is preferably provided that the one or more stamping dies comprise a material or a combinations of materials selected from: steel, silicone, plastic, aluminum, copper, brass and/or magnesium.

Further, it is possible for the stamping station to have at least one film feed unit, wherein the film feed unit comprises two or more film spindles which wind and unwind two or more film webs, wherein the two or more film webs are preferably arranged next to one another in parallel and are preferably slid in and out between the stamping die and the base body. Here, it is in particular provided that two or more film webs with different structures, colors, surface finishes etc. can be used, with the result that a wide variety of designs and functions of the coated base bodies are formed. Further, the advantage results in particular that the set-up times are reduced as the frequency of changing the film webs between the individual stamping steps can be reduced.

Further, it is preferably possible that the at least one film feed unit has at least one splicing aid and/or that the two or more film spindles can be removed, in particular for changing the film. By splicing aid is meant in particular a device for joining film webs, in particular by means of adhesive tapes. Further, it is preferably provided that the splicing aid comprises a vacuum unit which produces a vacuum in particular in the area of the splice, with the result that the adhesive bonding of the two or more film webs can be performed without air pockets. The in particular removable film spindles make it possible to change the film webs easily and rapidly.

Further, it is possible for the film feed unit in particular to have at least one dual and/or multiple winder and unwinder, with which two and/or more film webs are wound and unwound. It is preferably provided that the film feed unit further has at least one height-adjustable deflection roller, at least one brake drive and/or at least one electric swivel roller for releasing tension in the film. Furthermore, it is possible for the film feed unit to comprise at least one servo drive which drives one or more film spindles. Furthermore, it is possible for the film feed unit to comprise at least one adjustable pressure roller.

Further, it is possible for the coating device to have at least one film-control unit which examines the two or more film webs for cracks in the film, film end and/or film stock, preferably by means of at least one sensor and/or by means of two or more servo motors, which are arranged on the two or more film spindles.

In particular, the sensor is an optical sensor, for example a camera. Such an examination is preferably effected using image-processing methods and, for example when a fault is detected, can send a signal to the machine setter in order that they can correct it.

With respect to the printing station, it is in particular provided that the at least one printing station comprises a digital printing station and/or an inkjet printing station and/or a pad printing station and/or an inkjet printing station. It is further preferred that the at least one printing station comprises at least one printing unit, which in particular has at least one printhead.

Here, it is in particular provided that the at least one printing unit has at least one linear drive, in particular at least one high-precision linear drive, which allows the at least one printing unit to move in one spatial direction, preferably in two spatial directions, further preferably in three spatial directions.

Further, it is preferably provided that the at least one printhead of the at least one printing unit has at least one linear drive, in particular at least one high-precision linear drive, which allows the at least one printhead to move in one spatial direction, preferably in two spatial directions, further preferably in three spatial directions.

For the method it is in particular possible for the application of the one or more printed layers to be carried out by means of digital printing and/or inkjet printing and/or inkjet printing and/or pad printing.

It is in particular provided that the at least one printhead applies the one or more printed layers. Further, it is possible for the one or more printed layers to contain one or more materials, in particular selected from: printing ink, in particular printing ink with colors from the CMYK and/or RGB color model and/or spot colors and/or transparent printing ink, in particular clear varnish and/or protective varnish (ClearCoat), and/or adhesive, in particular cold adhesive and/or UV adhesive, and/or varnishes. The CMYK color model is composed in particular of the colors C=cyan; M=magenta; Y=yellow; K=black and the RGB color model is composed of the colors R=red; G=green; B=blue. Spot colors can originate from the PANTONE® color system, for example. It is in particular provided that each printhead provides one color. Preferably, by additive or subtractive overlaying and/or mixing of the individual color components, which can be applied as one or more printed layers, any desired colors are produced.

Analogously, for the method the result in particular is that the application of the one or more printed layers in step c) is carried out by means of one or more printheads which contain printing ink, in particular printing ink with colors from the CMYK and/or RGB color model and/or spot colors and/or transparent printing ink, in particular clear varnish and/or protective varnish (ClearCoat), and/or adhesive, in particular cold adhesive and/or UV adhesive, and/or varnishes, which are preferably applied as a printed layer to the at least one partial area of the first surface of the base body and/or the at least one partial area of the one or more film elements stamped on the base body and/or to the at least one partial area of the one or more further printed layers applied to the base body.

It is furthermore also provided that the one or more printed layers applied to the base body are partially cured and/or fully cured.

Furthermore, it is in particular provided that the coating device has at least one UV-irradiation unit for the UV precuring, in particular pinning, of one or more printed layers of the one or more printed layers, and/or at least one UV-irradiation unit for the full curing of one or more printed layers of the one or more printed layers, wherein the UV-irradiation unit comprises a UV radiation-emitting light source which preferably emits light in the wavelength range of from 385 nm to 405 nm. It is in particular provided that the one or more printed layers to be cured comprise one or more materials selected from: UV adhesive, cold adhesive, adhesive, varnish and/or ink.

The UV precuring, in particular pinning, works with a comparatively low power of the UV-irradiation unit, wherein for example the power consumption of a corresponding UV LED lies between 1 watt and 5 watts. The UV-irradiation unit for full curing works with a comparatively high power of the UV-irradiation unit, wherein for example the power consumption of a corresponding UV LED lies between 10 watts and 50 watts.

It is further possible for the at least one UV-irradiation unit to comprise at least one linear drive, in particular at least one high-precision linear drive, which allows the at least one UV-irradiation unit to move in one spatial direction, preferably in two spatial directions, further preferably in three spatial directions.

The method preferably comprises the following step, wherein the step is performed in step c):
UV irradiation, in particular pinning, by means of a UV light, preferably a UV LED, for the precuring of one or more printed layers of the one or more printed layers, in particular UV adhesive, cold adhesive, adhesive, varnish and/or ink, in particular wherein the irradiation is carried out with light, in particular from the wavelength range of from 385 nm to 405 nm.

The method particularly preferably further comprises the following step, wherein the step is performed in step c):
UV irradiation by means of a UV light, preferably a UV LED, for the full curing of one or more printed layers of the one or more printed layers, preferably UV adhesive, cold adhesive, adhesive, varnish and/or ink, in particular wherein the irradiation is carried out with light, in particular from the wavelength range of from 385 nm to 405 nm.

In addition to the at least one stamping station and the at least one printing station, at least one pretreating station is in particular also provided. In particular, it is provided that the coating device has at least one pretreating station for pretreating a partial area of the surface of the base body, the one or more film elements stamped on the base body and/or the one or more printed layers applied to the base body, in particular using one or more processing methods selected from: treatment with gas, flame treatment, plasma treatment, fluorination, irradiation, cleaning, surface activation, coating, ionization.

Furthermore, it is in particular also provided that the method comprises the following step, in particular wherein the step is carried out once or multiple times before step b) and/or before step c):
pretreating the at least one partial area of the first surface of the base body and/or the at least one partial area of the one or more film elements stamped on the base body and/or the at least one partial area of the one or more printed layers applied to the base body, in particular using one or more processing methods selected from: treatment with gas, flame treatment, plasma treatment, fluorination, irradiation, cleaning, surface activation, ionization, coating.

It is particularly advantageous here that, because of the “closeness” in time of the pretreatment both to the stamping process and to the printing process, the pretreated surface is particularly “accessible” for the processing methods carried out and—due to the closeness in time—a degeneration is largely avoided. The effectiveness of the pretreatment is thus considerably increased, and for example the adhesion properties between the base body and the one or more film elements and/or the one or more printed layers are improved.

In particular, the ionization makes it possible to reduce the electrostatic charge, as a result of which the stamping of the one or more film elements is designed to be more efficient. In particular, through the transport of the ions using electrically operated ventilator elements, a special vertical distance adjustment is unnecessary due to a comparatively long-range effect of approx. 500 mm. Since the functioning of the ionization is invisible for the operator, any disturbance of the unit arising is signaled in the control system by an integrated monitoring function.

The coating device preferably has at least one checking station for optically checking at least one partial area of the surface of the base body, the one or more film elements stamped on the base body and/or the one or more printed layers applied to the base body by means of an optical sensor, in particular a camera.

It is furthermore in particular provided that, before step b) and/or step c), an optical check of the at least one partial area of the surface of the base body and/or of the at least one partial area of the one or more film elements stamped on the base body and/or of the at least one partial area of the one or more printed layers applied to the base body is effected by means of an optical sensor, in particular a camera.

Such an optical check is preferably carried out here using image-processing methods and can, for example, be used to optimize process parameters for example by incorporation into a corresponding control loop, in order thus to further reduce the reject rates. Further, this optical check can also be used for quality assurance. This optical check can take place multiple times at different times in the process, for example after the stamping process and/or after the pretreatment and/or after the printing process and/or after cleaning processes and/or after the removal of the coated base body from the holding device and/or after further processing methods.

Further, it is possible for the coating device to have at least one cleaning station, in particular for cleaning at least one surface of the base body and/or one or more film elements stamped on the base body and/or one or more printed layers applied to the base body by means of brushes and/or compressed air and/or suction and/or CO₂ snow blasting and/or adhesive tape, in particular by means of pad cleaning tape and/or roll cleaning tape.

It is in particular provided that the method comprises the following step, in particular wherein the step is performed before and/or after step b), and/or before and/or after step c):
cleaning, in particular by means of brushes and/or compressed air and/or suction and/or CO₂ snow blasting and/or adhesive tape, in particular by means of pad cleaning tape and/or roll cleaning tape.

Through this process, for example, the exposed surface is cleaned of waste products of the stamping process. The cleaning process is preferably carried out here while the base body is still located in the holding device. It is preferably hereby ensured that the base body is securely fixed during the cleaning process, with the result that cleaning methods which require a stable fixing of the product to be cleaned can also be used.

It is preferably possible for the coating device to have at least one flowbox, preferably at least one ventilator, for reducing dust and/or preventing dust, in particular wherein this blows filtered ambient air or room air into the working space with positive pressure. For the method, it is preferably possible, before and/or during and/or after step b) and/or step c), for the ingress of dust into the working space to be reduced, in particular to be prevented, by means of positive air pressure. This has the advantage that no dust particles or other particles enter the working space from outside, with the result that, for example, no dust inclusions form during the stamping or printing.

Here, the working space is preferably sealed against the surroundings and can particularly preferably be closed off from the surroundings. Furthermore, it is in particular provided that the working space comprises that space in which the at least one stamping station, the at least one printing station, the at least one pretreating station, the at least one cleaning station and/or the at least one checking station are arranged.

It is also possible for the method to comprise the following step, in particular wherein the step is performed after step d) in one or more further machines: flooding, overspraying and/or spray-coating the coated base body, and/or preferably laminating sensors, in particular sensors which are sensitive to touch and/or proximity, on the coated base body, in particular on the rear side of the coated base body.

In particular by combining the coated base body with sensors which are sensitive to touch and/or proximity, individual items of programming can be visualized through the corresponding decoration on the surface consistent with the corporate identity. Such sensors can be resistively or capacitively acting touch sensors.

The stamping of the one or more film elements in step b) is preferably carried out by means of roll-on stamping and/or partial roll-on stamping and/or vertical stamping. Further, it is also possible to use corresponding stamping methods for this, which are specifically optimized for three-dimensionally formed surfaces and such as are described for example in DE 102012109315 A.

It is preferably possible for the stamping of the one or more film elements in step b) to be carried out by means of one or more stamping dies, which applies a film or one or more sections of a film as film element to the at least one partial area of the first surface of the base body and/or the at least one partial area of the one or more further film elements stamped on the base body and/or to the at least one partial area of the one or more printed layers applied to the base body.

It is also in particular provided that the application of the one or more film elements is effected by means of stamping rollers. The one or more stamping rollers are preferably correspondingly matched to the shape of the base body and/or make a corresponding following of the contours with respect to the surface contour of the first surface of the base body possible in their guiding and in their roll-on behavior, or are matched thereto.

In particular transfer films, for example hot-stamping films or cold-stamping films, but also laminating films, come into consideration as films when step b) is carried out.

Transfer films which comprise a carrier ply and a transfer ply detachable therefrom are particularly suitable for use here. The carrier ply here preferably consists of a plastic film, for example a PET film with a thickness of between 5 μm and 250 μm. The transfer ply here has one or more layers which are preferably selected from: one or more decorative layers, one or more functional layers, one or more protective layers, one or more adhesion-promoting layers, one or more barrier layers, one or more conductive layers.

Further, it is advantageous if one or more detachment layers, which improve the detachability, are arranged between the carrier ply and the transfer ply. Such layers preferably contain waxes and/or silicones and/or polymers.

If such a transfer film is designed as a hot-stamping film, it preferably has a thermally activatable adhesive layer, which can in particular be activated by the thermal energy of the stamping die and/or the stamping roller, on the side of the transfer film facing away from the carrier ply. The carrier film is then peeled off again with the portions of the transfer ply which were not acted on by the stamping die and/or the stamping roller.

If such a transfer film is designed as a cold-stamping film, a UV-curable adhesive layer is applied, in particular printed on, for example by means of gravure printing and/or offset printing and/or flexographic printing and/or inkjet printing and/or pad printing, to the base body and/or to the side of the transfer film facing away from the carrier ply, and is activated and cured by means of UV radiation after the cold-stamping film and base body have been brought together. The carrier film is then peeled off again with the portions of the transfer ply which were not joined to the adhesive layer.

Further, it is also possible for the transfer ply of the transfer film further to have, for example, openings introduced by means of punching or cutting or laser exposure or for the transfer ply to be provided in the form of patches on the carrier ply. Such transfer plies further preferably also have another one or more carrier films for stabilizing the transfer ply. This further results in the advantage that “sensitive” functional and decorative layers receive an additional protection from the thermal and mechanical stresses of the stamping process or the subsequent process steps.

It is preferably provided that a laminating film is used as film in step b) and, during the stamping, at least one section of the laminating film determined by the shape of the stamping die is applied as film element by activating an adhesive layer of the laminating film or an adhesive layer provided between the surface of the base body and the laminating film.

Laminating films preferably do not have a “detachable” carrier ply, i.e. the carrier ply and the further layers form a firmly bonded composite. Laminating films preferably have one or more of the following layers: one or more decorative layers, one or more functional layers, one or more protective layers, one or more carrier layers, one or more adhesion-promoting layers, one or more carrier films, one or more barrier layers, one or more conductive layers.

The laminating films here preferably have in particular openings introduced by punching and/or cutting and/or laser exposure or are already delivered to the stamping process during the stamping in the form of tags, labels or similar individual elements, which in particular can be arranged on an auxiliary carrier.

The one or more film elements applied by means of the one or more stamping dies or stamping rollers preferably have a shape which can be predetermined to a large extent by the design of the one or more stamping dies or stamping rollers, the shape of the film or the transfer ply of the film and/or by further measures, as described further below. These film elements are determined with respect to their layer structure by the corresponding layer structure of the film used for the stamping or the transfer ply of the film used for the stamping. The one or more film elements thus preferably have in any case one or more layers selected from: one or more decorative layers, one or more functional layers, one or more protective layers, one or more adhesion-promoting layers, one or more adhesive layers, one or more carrier layers, one or more carrier films.

It is in particular provided that the one or more film elements and/or the one or more further film elements in each case have at least one decorative layer and/or at least one functional layer, in particular a layer with an electrical functionality, in particular comprising one or more elements selected from touch sensor, antenna, electromagnetic shielding, electrically non-conductive, metallic layers for preventing electrostatic charge, display, LED, electric circuit, solar cell, at least one, in particular post-curable, protective layer and/or at least one adhesion-promoting layer.

One decorative layer or the decorative layers preferably consist of one or a combination of the following decorative layers:
transparent or translucent or opaque varnish layer containing dyes and/or pigments, in particular organic/inorganic pigments, luminescent and/or fluorescent pigments and/or dyes, optically variable pigments, thermochromic pigments and/or dyes, metallic pigments, magnetically alignable pigments
volume hologram layer,
layer with optically active surface relief, in particular a diffractive and/or refractively acting surface relief, a holographic surface relief, a surface relief containing refractive structures, diffractive structures, in particular lens structures, microlens arrangements, microprisms, micromirrors, matte structures, in particular isotropic and/or anisotropic matte structures and/or a combination of any such structures;
reflective layers, in particular metallic or dielectric reflective layers;
high-refractive-index or low-refractive-index layers, in particular with refractive indices which differ from a refractive index of 1.5 by more than +/−0.2;
liquid-crystal layers, in particular cholesteric and/or nematic liquid-crystal layers;
thin-film layers which display an optically variable color-change effect, in particular a three-layer structure comprising an absorber layer, a dielectric spacer layer and an optional reflective layer or alternatively comprising a multiple sequence of alternating high-refractive-index and low-refractive-index transparent layers.

These decorative layers can here be applied to each other and/or next to each other in any desired sequence. Each individual decorative layer can here be formed patterned over part of the surface, in order to achieve in particular a desired graphic decoration. The decorative layers are preferably arranged registered relative to each other.

The functional layer or the functional layers preferably consist of one or a combination of the following functional layers mentioned: layers with an electrical functionality, in particular comprising one or more elements selected from: touch sensor, antenna, electromagnetic shielding, electrically non-conductive, metallic layers for preventing electrostatic charge, display, LED, electric circuit, solar cell, layer with a magnetic functionality, for example a magnetic barcode, layers with mechanical functionality, for example reinforcing elements or stiffening elements made of metal and/or plastic and/or woven and/or unwoven fiber plies and/or fibrous additives and/or fibrous additional layers, layers with optical functionality, for example anti-reflection layers or reflective layers, layers with tactile functionality, for example soft-touch surface coatings.

It is possible for a hot-stamping film comprising a carrier ply and a transfer ply detachable therefrom to be used as film in step b) and/or, during step b), at least one section of the transfer ply determined by the shape of the stamping die to be applied as film element by activating an adhesive layer of the transfer ply or an adhesive layer provided between the base body and the transfer ply.

It is further possible for a transfer film, in particular a cold-stamping film, comprising a carrier ply and a transfer ply detachable therefrom, to be used as film in step b), which an adhesive layer, in particular selected from cold adhesive and/or UV adhesive, is applied, in particular by means of an inkjet printhead, to the transfer ply and/or to a partial area of the surface of the base body in a first area, but is not applied in a second area, the transfer film is guided in particular by means of the stamping die towards the surface of the base body, the adhesive layer is activated and the transfer film is peeled off again, with the result that a section of the transfer ply determined by the shape of the first area is applied as film element.

The adhesive layer is preferably cured by means of high-energy electromagnetic radiation, for example by means of UV irradiation and/or IR irradiation and/or electron beam radiation. The curing can be effected in particular before and/or during and/or after the application of the transfer ply to the adhesive layer. If the curing is effected before the application of the transfer ply to the adhesive layer, the adhesive layer can thereby be precured in order, for example, to increase (IR irradiation) or to reduce (UV irradiation) the viscosity of the adhesive layer in a targeted manner. If the curing is effected during the application of the transfer ply to the adhesive layer, the curing can be effected with the carrier ply still joined to the transfer ply. If the curing is effected after the application of the transfer ply to the adhesive layer, the curing can be effected with the carrier ply already peeled off the transfer ply and exposed transfer ply from the upper side of the base body.

During the curing of the adhesive layer, still further layers and/or partial areas of the base body and/or one or more printed layers and/or one or more further printed layers can also be cured with it at the same time or post-cured by the radiation acting on the base body one or more film elements and/or the one or more further film elements.

It is furthermore also possible for the one or more printed layers and/or the one or more further printed layers to be cured separately. Here, reference should be made in particular to the UV irradiation described above.

Furthermore, in particular in the case of base bodies formed transparent, it is provided to carry out a decoration or coating on both sides, with the result that a depth effect forms through the spacing of the two decorations due to the wall thickness of the base body. For this, the thickness of the base body is preferably chosen such that the one or more film elements on the one hand and the one or more further film elements on the other hand are spaced apart from each other such that an optical depth effect is generated by the interaction of the one or more film elements and one or more further film elements.

If the base body is formed opaque for example, the decoration on both sides can provide a different optical appearance of the base body from different sides through the one or more film elements and the one or more further film elements.

Through the use of one or more film elements and one or more further film elements, a combination of decorative films and functional films can also be effected. For example, a decoration can be effected on one side of the base body and an application of a functional element, for example a touch sensor or an antenna or a display, can be effected on the other side of the base body.

For this purpose, it is in particular advantageous for the coating device to have a device for turning the base body. Further, for this it is in particular advantageous for the adjusting device to have a further mold carrier for the turned base body, since it is possible in particular for the rear side of the base body to be formed differently from the front side of the base body. It is preferably possible for the turning device to have a robot arm, for example, which removes the base body from one mold carrier, rotates the base body correspondingly and places or arranges it in the further mold carrier in the rotated position.

During the printing in step c) it is possible for one at least further partial area to lie inside the at least one partial area of the first surface of the base body and/or the at least one partial area of the one or more film elements stamped on the base body and/or the at least one partial area of the one or more further printed layers applied to the base body. In this case, the printing is effected in particular on the free surfaces of the base body and/or the one or more film elements stamped on the base body and/or on the one or more further printed layers applied to the base body.

However, it is also possible for the at least one further partial area to lie only in the exposed first partial area of the surface of the base body. In this case, the printing is effected in particular next to or adjacent to the one or more film elements stamped on the base body and/or the one or more further printed layers applied to the base body.

Furthermore, it is further possible for the at least one further partial area to lie both inside the at least one partial area in which the one or more film elements stamped on the base body and/or the one or more further printed layers applied to the base body are applied, and to lie in the exposed first partial area of the surface of the base body. In this case, the printing overlaps both the one or more film elements stamped on the base body and/or the one or more further printed layers applied to the base body and the exposed first partial area of the surface of the base body at least in areas.

It is furthermore advantageous if the application of the one or more printed layers is effected register-accurate relative to the one or more film elements stamped on the base body and/or the one or more further printed layers applied to the base body, for which in particular one or more register marks or optical features of the one or more film elements stamped on the base body and/or of the one or more further printed layers applied to the base body and/or of the holding device are detected, for example with a camera, and used to control the application of the one or more printed layers.

The application of the one or more printed layers in the at least one further partial area preferably represents at least one decoration or a visually recognizable design element, which can be for example a graphically designed outline, a figurative representation, an image, a motif, a symbol, a logo, a portrait, a pattern, a grid, an alphanumeric character, a text and the like.

In the following the invention is explained by way of example with reference to several embodiment examples utilizing the attached drawings. The embodiment examples shown are therefore not to be understood as limitative.

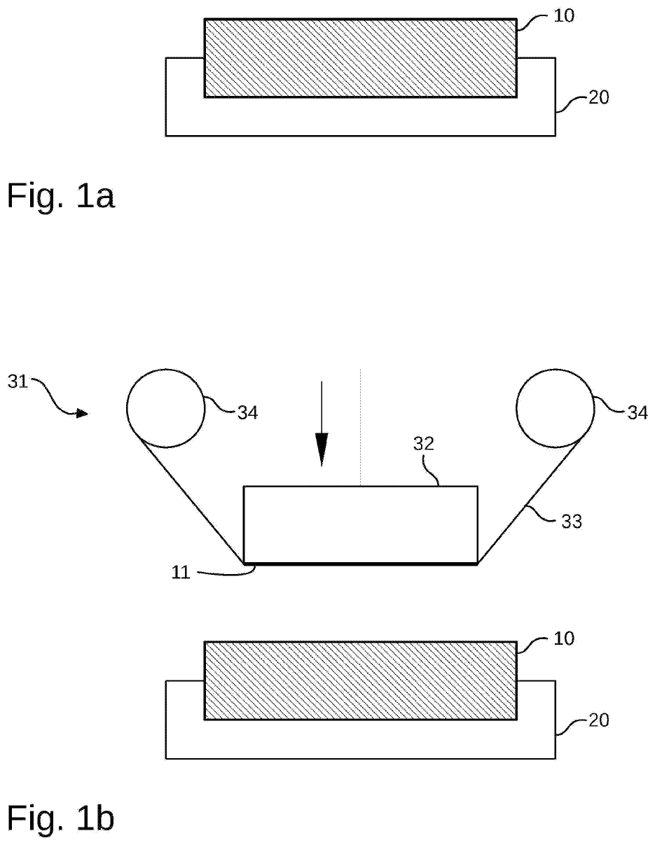

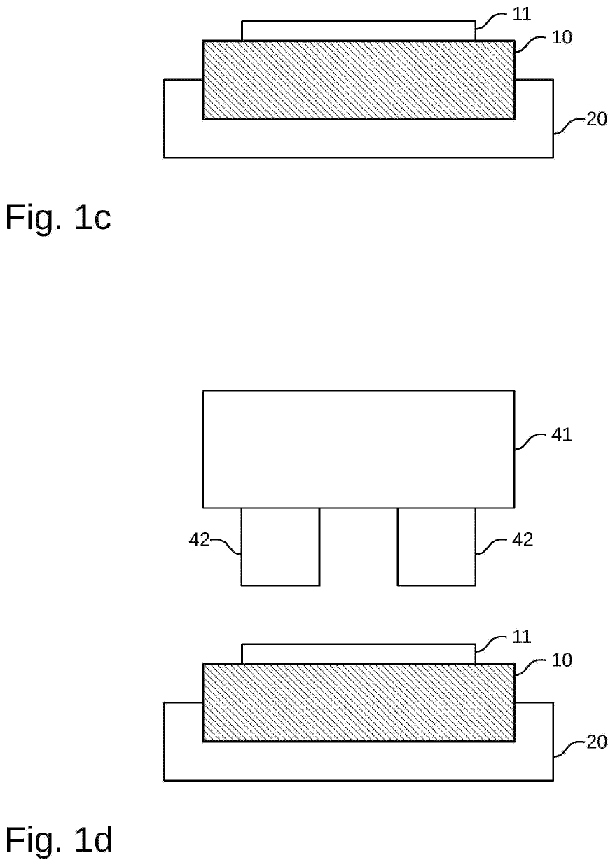

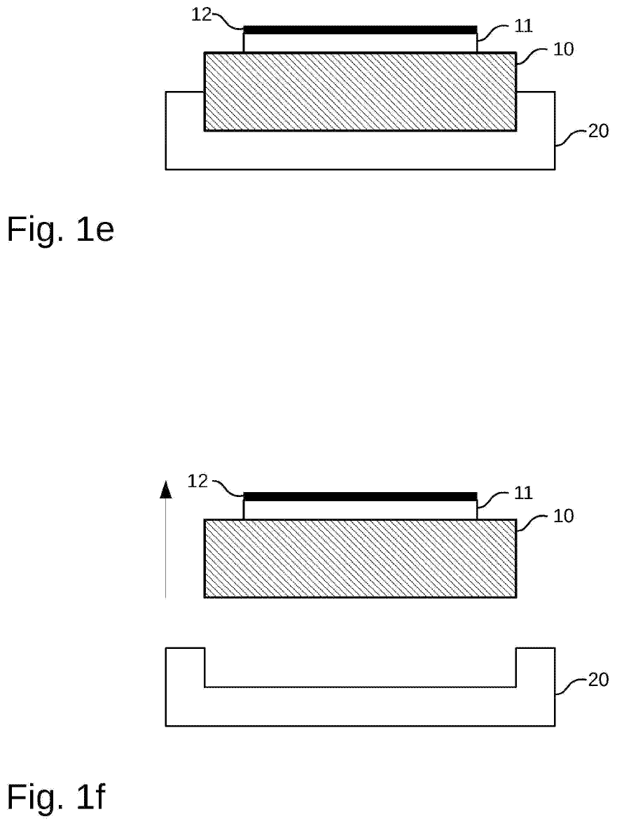

FIG. 1a-FIG. 1f illustrates, with reference to several schematic representations, the performance of a method for coating a base body.

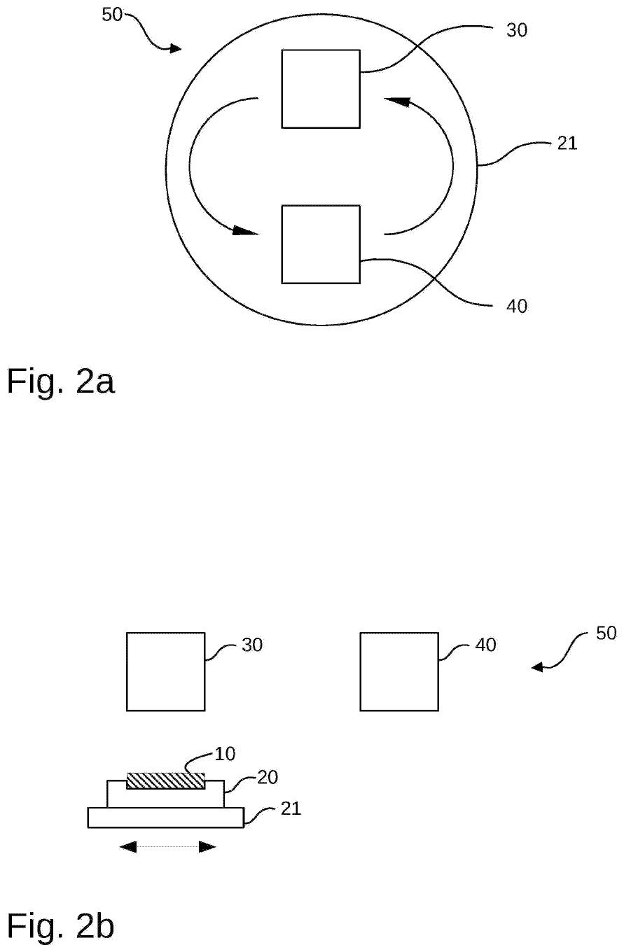

FIG. 2a, FIG. 2b in each case illustrates a schematic representation of a coating device for producing a coated base body.

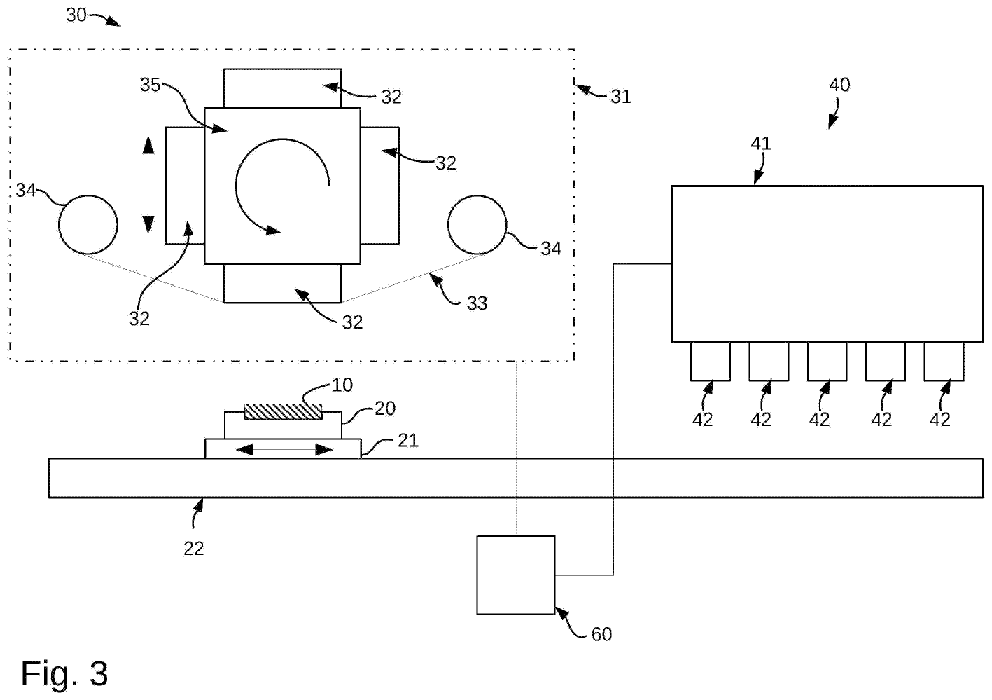

FIG. 3 shows a schematic representation of a coating device for coating a base body.

FIG. 4a-FIG. 4c illustrates, with reference to several schematic representations, a method for coating a base body

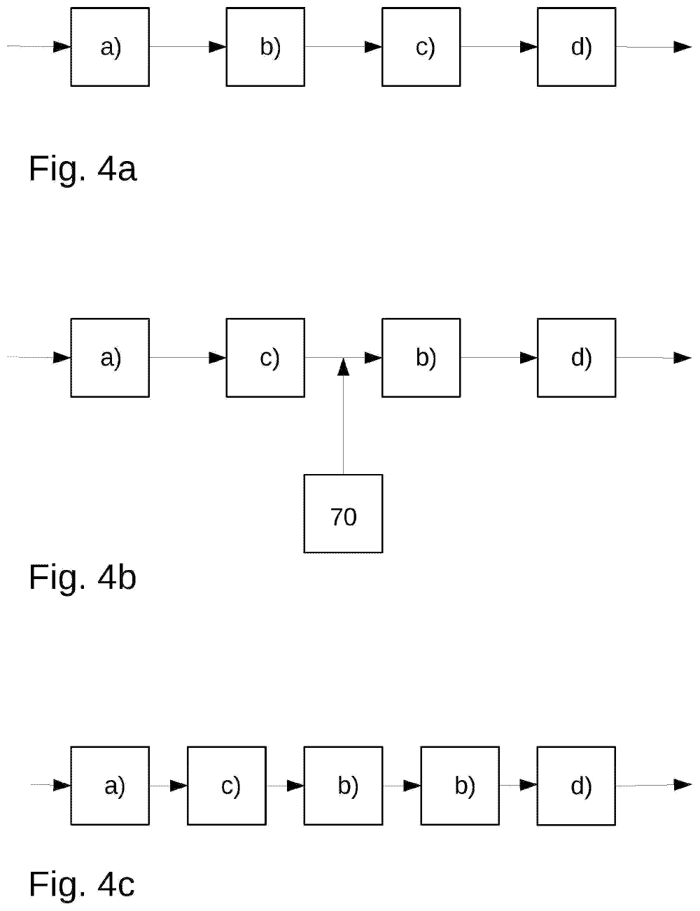

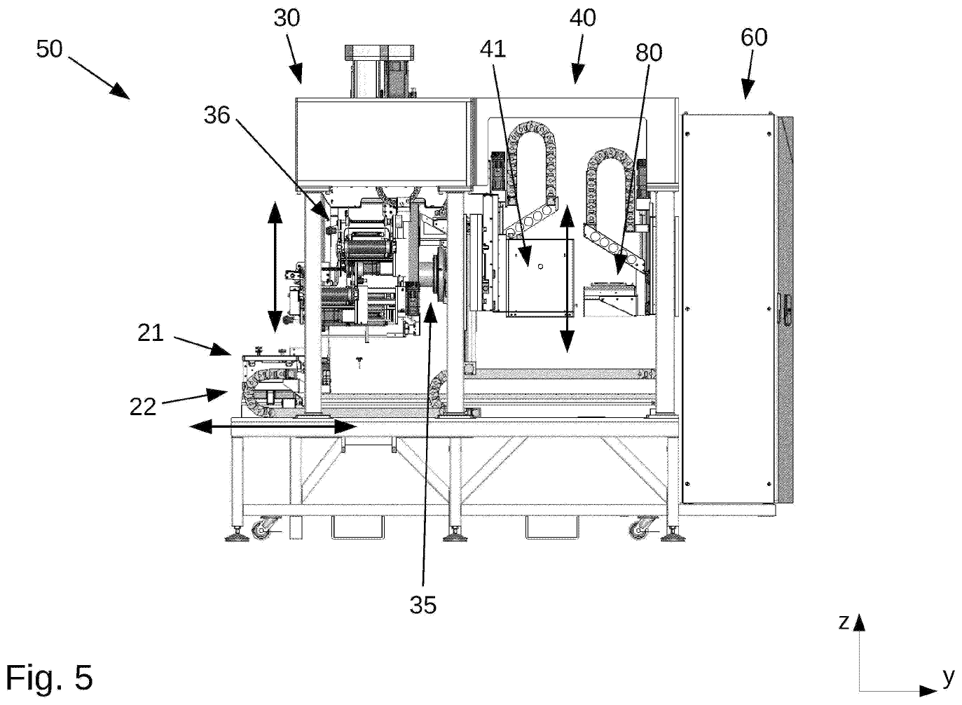

FIG. 5 shows a representation of an exemplary coating device

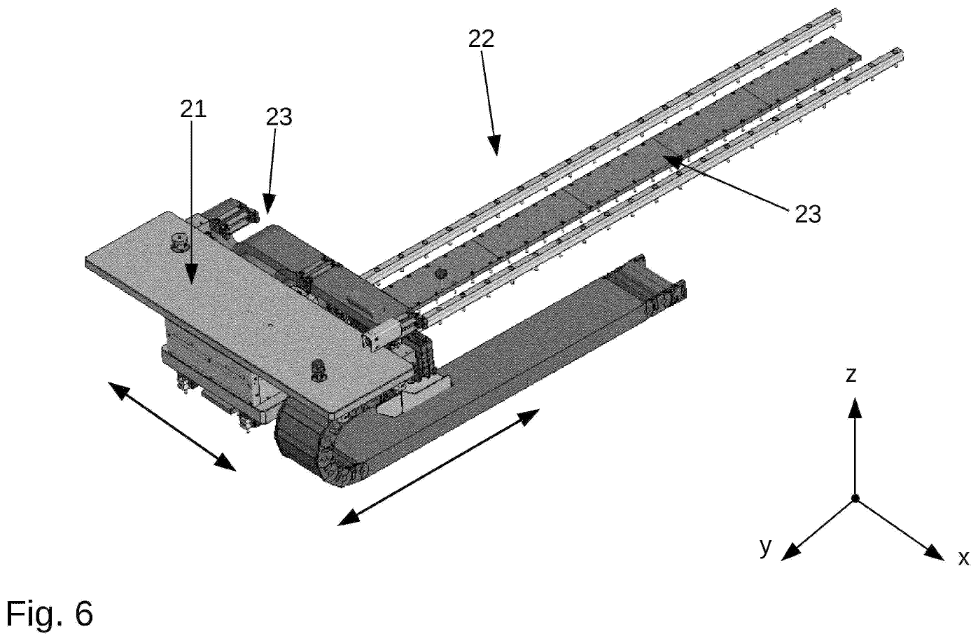

FIG. 6 illustrates an exemplary representation of an adjusting device and of a mold carrier

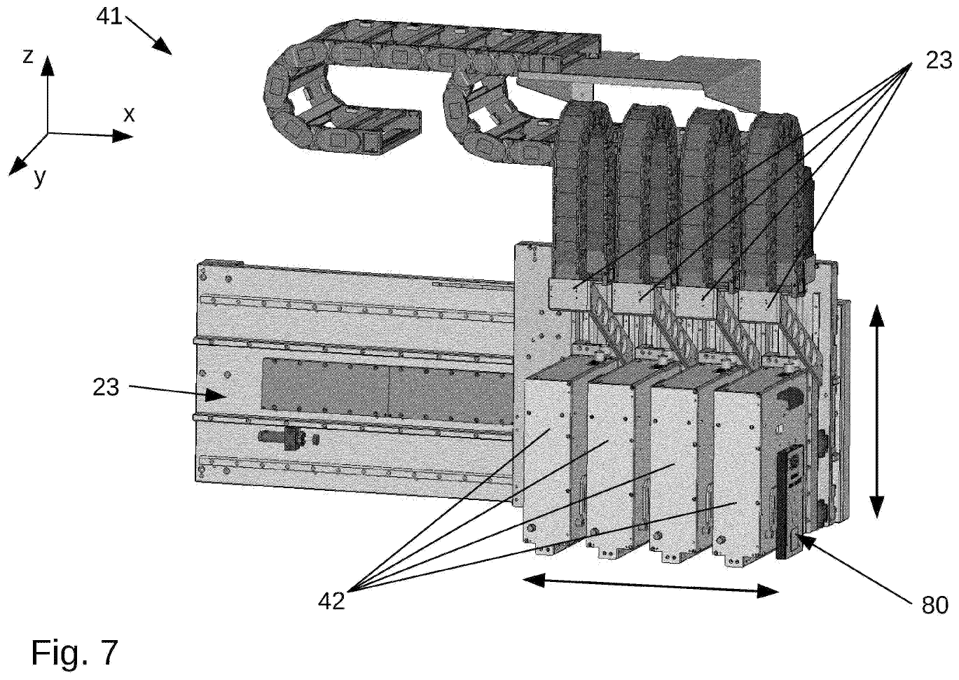

FIG. 7 shows an exemplary representation of a printing unit

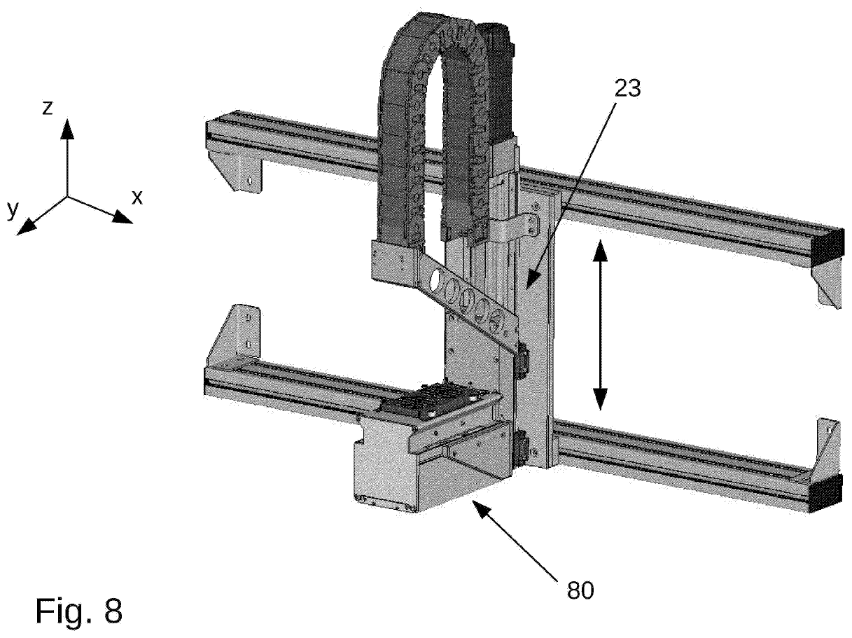

FIG. 8 shows an exemplary representation of a UV-irradiation unit

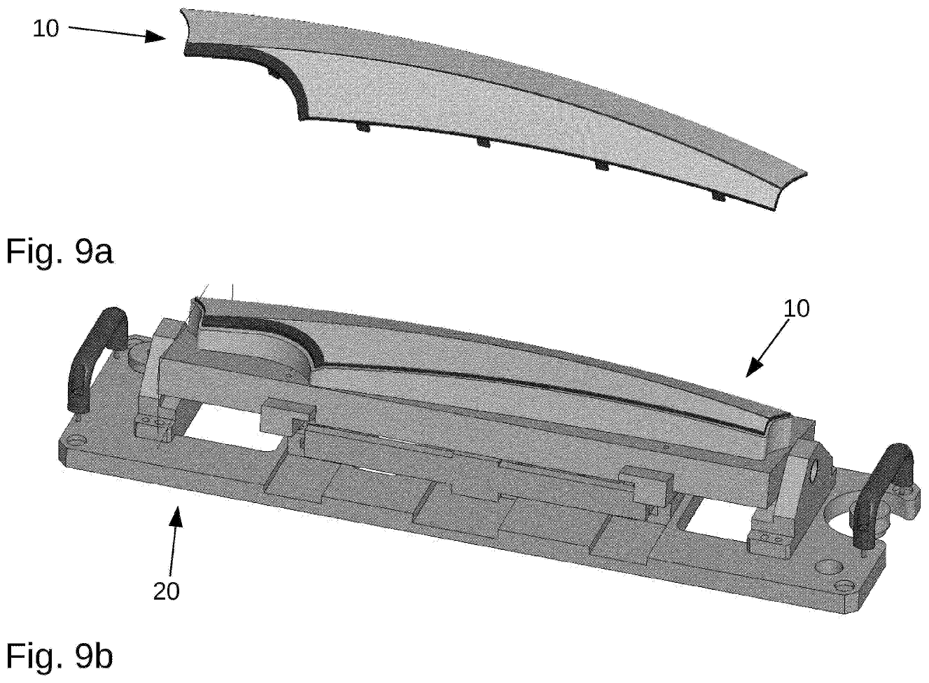

FIG. 9a shows an exemplary representation of a base body

FIG. 9b shows an exemplary representation of a holding device

A method for producing a coated base body is described in the following with reference to FIGS. 1a to 1f:

FIG. 1a shows a holding device 20 in which a base body 10 is fixed, preferably is fixed in a positive-locking and/or a non-positive-locking manner. It is in particular provided that the holding device 20 can be opened and/or closed mechanically and/or hydraulically and/or pneumatically and/or electrically and/or by hand. The placing of the base body 10 is preferably effected by human hand, by a conveying device which leads to the holding device 20, or completely automated, for example by a robot.

The base body 10 is preferably a rigid body which in particular has at least one surface that is curved, even and/or uneven in areas.

It is in particular possible for the base body 10 and/or a surface of the base body 10, in particular the surface of the base body 10 to be coated, to be substantially flat, in particular two-dimensionally even, or 2.5-D deformed or three-dimensionally deformed.

Further preferably, the base body 10 comprises a component, in particular a vehicle part, a housing part, a cockpit component and/or a bodywork part, an injection-molded part, a 3D-printed part and/or a component produced by means of cutting and/or non-cutting production methods.

In a next step, one or more film elements 11 are then applied to at least one partial area of a first surface of the base body 10, in particular in a stamping station 30 of the coating device 50, as illustrated in FIG. 1b. In particular, it is also provided that one or more film elements 11 are applied to at least one partial area of one or more further film elements 11 stamped on the base body 10 and/or to at least one partial area of one or more printed layers 12 applied to the base body 10. In particular, the base body 10 remains in the holding device 20 during the stamping.

The base body 10 which is fixed in the holding device 20 and is located at the stamping station 30 is represented in FIG. 1b. The stamping station 30 has a stamping unit 31, which has a stamping die 32 and a film feed unit 36 in this embodiment. The film feed unit 36 comprises two film spindles 34, which wind and unwind the film webs 33. For stamping a film element 11, the stamping die 32 is moved in a translational manner in the direction of the base body 10, as indicated by the arrow. As a result of a stamping pressure and a heat input, the film element 11 is then applied to the base body 10. The base body 10 coated with a film element 11 is represented in FIG. 1c as the result. Here, the base body 10 is preferably still arranged fixed in the holding device 20. However, it is also possible for one or more film elements 11 to be stamped on the base body 10.

The stamping station 30 preferably has at least one stamping unit 31, which comprises one or more stamping dies 32. Further, it is possible for the coating device 50 to have at least one film feed unit 36, wherein the film unit comprises two or more film spindles 34 which wind and unwind two or more film webs 33, wherein the two or more film webs 33 are preferably arranged next to one another in parallel and are preferably slid in and out between the stamping die 32 and the base body 10.

In an alternative design variant it is possible that the at least one film feed unit 36 has at least one splicing aid and/or that the two or more film spindles 34 can be removed, in particular for changing the film.

For stamping the one or more film elements 11, the one or more stamping dies 32 are preferably moved in a translational manner in the direction of the base body 10 until the film element 11 comes into contact with the base body 10. If the contact is produced, an in particular predefined stamping pressure is subsequently applied and, by means of a heat input, the film element 11 is stamped on the base body 10. It is possible for the one or more stamping dies 32 each to have at least one direct heater for rapidly heating the stamping die 32. Furthermore, it is in particular provided that the heating range of the one or more stamping dies 32 lies between 0° C. and 300° C., in particular lies between 80° C. and 250° C.

It is further provided that the stamping of the one or more film elements 11 in step b) is carried out by means of roll-on stamping and/or partial roll-on stamping and/or vertical stamping.

In a preferred design variant it is provided that a hot-stamping film comprising a carrier ply and a transfer ply detachable therefrom is used as film 33 in step b) and/or, during step b), at least one section of the transfer ply determined by the shape of the stamping die 32 is applied as film element 11 by activating an adhesive layer of the transfer ply or an adhesive layer provided between the base body 10 and the transfer ply.

Further, it is preferred for a transfer film, in particular a cold-stamping film, comprising a carrier ply and a transfer ply detachable therefrom, to be used as film 33 in step b). The cold-stamping film which is applied to the transfer ply and/or to a partial area of the surface of the base body 10 is preferably an adhesive layer, in particular selected from cold adhesive and/or UV adhesive, in particular applied by means of an inkjet printhead 42 in a first area, but not applied in a second area. In particular, the transfer film is guided by means of the stamping die 32 towards the surface of the base body 10, the adhesive layer is activated and the transfer film is peeled off again, with the result that a section of the transfer ply determined by the shape of the first area is applied as film element 11.

It is also possible for a laminating film to be used as film 33 in step b) and, during the stamping, at least one section of the laminating film determined by the shape of the stamping die 32 to be applied as film element 11 by activating an adhesive layer of the laminating film or an adhesive layer provided between the surface of the base body 10 and the laminating film.

The base body 10 which is coated with a film element 11 and is located at the printing station 40 is represented in FIG. 1d, wherein the base body 10 still remains in the holding device 20. The printing station 40 has a printing unit 41, which comprises two printheads 42. It is furthermore also possible for the printing station 40 to have at least one printing unit 41, which in turn comprises one or more printheads 42 and by means of which the one or more printed layers 12 are applied.

In a next step, one or more printed layers 12 are then applied to at least one partial area of the one or more film elements 11 stamped on the base body 10, in particular in a printing station 40 of the coating device 50. In a further design variant it is also provided that one or more printed layers 12 are applied to at least one partial area of a first surface of the base body 10 and/or to at least one partial area of one or more further printed layers 12 applied to the base body 10. It is in particular provided that the base body 10 remains in the holding device 20.

In particular, the application of the one or more printed layers 12 is carried out by means of digital printing and/or inkjet printing and/or inkjet printing and/or pad printing.

Further, it is in particular provided that the application of the one or more printed layers 12 in step c) is carried out by means of one or more printheads 42, which contain printing ink, in particular printing ink with colors from the CMYK and/or RGB color model and/or spot colors and/or transparent printing ink, in particular clear varnish and/or protective varnish (ClearCoat), and/or adhesive, in particular cold adhesive and/or UV adhesive, and/or varnishes, which are preferably applied as a printed layer 12 to the at least one partial area of the first surface of the base body 10 and/or the at least one partial area of the one or more film elements 11 stamped on the base body 10 and/or to the at least one partial area of the one or more further printed layers 12 applied to the base body 10.

The base body 10 coated with a film element 11 and a printed layer 12 is represented in FIG. 1e, wherein it is still fixed in the holding device 20 in a positive-locking and/or a non-positive-locking manner.

The removal of the coated base body 10 from the holding device 20 in a further step is shown in FIG. 1f. This is indicated by the arrow. After the removal of the coated base body 10, it is then possible to carry out further processing steps, which are preferably performed in separate machines.

Thus, it is possible for the method to comprise the further step, in particular wherein the step after the removal of the coated base body 10 from the holding device 20 is performed in one or more further machines:
flooding, overspraying, and/or spray-coating the coated base body 10, and/or preferably laminating sensors, in particular sensors which are sensitive to touch and/or proximity, on the coated base body 10, in particular on the rear side of the coated base body 10.

FIG. 2a shows a schematic representation of the coating device 50, comprising a mold carrier 21 which is preferably implemented as a rotary plate and moves the holding device 20, not represented in this figure, together with the base body 10 between the stamping station 30 and the printing station 40.

A schematic representation of the coating device 50 is likewise shown in FIG. 2b, wherein in this embodiment variant the coating device 50 has a mold carrier 21, which comprises a sliding table and/or a linear unit 23 and moves the holding device 20, with the base body 10 fixed therein in a positive-locking and/or a non-positive-locking manner, between the stamping station 30 and the printing station 40.

FIG. 3 illustrates an embodiment of the coating device 50 according to FIG. 2b in which the mold carrier 21 comprises a sliding table and/or a linear unit. In addition to the mold carrier 21, the coating device 50 has an adjusting device 22, which moves the mold carrier 21 between the stamping station 30 and the printing station 40 in a translational manner, as indicated by the double arrow. A holding device 20, in which the base body 10 is arranged fixed in particular in a positive-locking and/or a non-positive-locking manner, is further arranged on the mold carrier 21. Further, the coating device 50 comprises a process-control device 60. The process-control device 60 comprises one or more microprocessors, peripheral components for controlling the stamping station 30, the printing station 40 and the adjusting device 22, as well as corresponding software components.

It is furthermore in particular provided that the coating device 50 has at least one holding device 20 for fixing a base body 10, at least one stamping station 30 and at least one printing station 40 for applying one or more printed layers 12 to at least one partial area of a first surface of the base body 10 and/or at least one partial area of one or more film elements 11 stamped on the base body 10 and/or at least one partial area of one or more further printed layers 12 applied to the base body 10, and that the stamping station 30 has one or more stamping units 31 for stamping one or more film elements 11 on at least one partial area of a first surface of the base body 10 and/or at least one partial area of one or more further film elements 11 stamped on the base body 10 and/or at least one partial area of one or more printed layers 12 applied to the base body 10.

The stamping station 30 has at least one stamping unit 31 for stamping one or more film elements 11. The stamping unit 31 preferably has at least one turret 35, on which at least one stamping die 32 is mounted. In the embodiment variant shown in FIG. 3, four stamping dies 32 are arranged on the turret 35.

It is further possible for the stamping station 30 to have at least one turret 35, which is preferably mounted rotatable about at least one axis and is movable in a translational manner along at least one axis. It is in particular provided that the turret 35 comprises one or more stamping die receivers which receive one or more stamping dies 32. The stamping dies 32 preferably have different geometries, with the result that different motifs can be stamped. The rotatable mounting of the turret 35 and the possibility of translational movement of the turret 35 are indicated by the arrows represented.

It is further provided in particular that the stamping station 30 has at least one film feed unit 36, wherein the film feed unit 36 comprises two or more film spindles 34 which wind and unwind two or more film webs 33. It is in particular possible for the two or more film webs 33 to be arranged next to one another in parallel, and wherein the two or more film webs 33 are slid in and out between the stamping die 32 and the base body 10.

In this embodiment variant, the turret 35 together with the stamping die 32 is moved in the manner of a lifting press translationally towards the base body 10. However, it is also possible for the stamping of the one or more film elements 11 to be carried out by means of roll-on stamping and/or partial roll-on stamping.

It is preferred for the one or more stamping dies 32 to be replaceably mounted on the one or more stamping die receivers of the at least one turret 35, preferably wherein each stamping die receiver in each case has a quick-change system for tool-free replacement of the stamping dies 32, preferably wherein the quick-change system has a dovetail bracket and/or a clamping lever for replacing the stamping dies 32.

This has the advantage that the stamping dies 32 can be replaced in particular without a tool, which considerably reduces the machine set-up times, in particular during maintenance or when changing to another base body 10.

It is also possible for the one or more stamping dies 32 not mounted on the turret 35 to be temporarily mounted in a bracket of the coating device 50 for preheating.

Further, it is possible for the one or more stamping dies 32 to comprise a material or a combinations of materials selected from: steel, silicone, plastic, aluminum, copper, brass and/or magnesium.

Further, it is in particular provided that the one or more stamping die receivers and the one or more stamping dies 32 are encoded, preferably are encoded by means of RFID chips.

It is furthermore also possible for the at least one printing station 40 to comprise a digital printing station and/or an inkjet printing station and/or a pad printing station and/or an inkjet printing station.

Furthermore, it is possible for the at least one printing station 40 to comprise at least one printing unit 41, which in particular has at least one printhead 42. The one or more printed layers 12 are applied by means of the at least one printhead 42. In particular, it is possible for each printhead 41 of the one or more printheads 42 to be arranged translationally movable separately, preferably to be arranged movable in the z direction, with the result that a constant processing distance from the surface of the base body 10 can be maintained. It is possible that the surface of the base body 10 can have irregularities and/or roughness, which is why a control of the at least one printhead 41 is effected, preferably by means of the process-control device 60, to maintain the processing distance.

It is in particular provided that the one or more printed layers 12 contain one or more materials, in particular selected from: printing ink, in particular printing ink with colors from the CMYK and/or RGB color model and/or spot colors and/or transparent printing ink, in particular clear varnish and/or protective varnish (ClearCoat), and/or adhesive, in particular cold adhesive and/or UV adhesive, and/or varnishes.

In an alternative embodiment variant it is possible for the coating device 50 to have at least one pretreating station 70 for pretreating a partial area of the surface of the base body 10, the one or more film elements 11 stamped on the base body 10 and/or the one or more printed layers 12 applied to the base body 10, in particular using one or more processing methods selected from: treatment with gas, flame treatment, plasma treatment, fluorination, irradiation, cleaning, surface activation, coating, ionization.

It is furthermore also possible for the coating device 50 to have at least one checking station for optically checking at least one partial area of the surface of the base body 10, the one or more film elements 11 stamped on the base body 10 and/or the one or more printed layers 12 applied to the base body 10 by means of an optical sensor, in particular a camera.

Expediently, it is possible for the coating device 50 to have at least one cleaning station, in particular for cleaning at least one surface of the base body 10 by means of brushes and/or compressed air and/or suction.

Preferably, it is possible for the coating device 50 to have at least one flowbox, preferably at least one ventilator, for reducing dust and/or preventing dust, in particular wherein this blows filtered ambient air or room air into the working space with positive pressure.

Here, the working space is preferably sealed against the surroundings and can particularly preferably be closed off from the surroundings. Furthermore, it is in particular provided that the working space comprises that space in which the at least one stamping station 30, the at least one printing station 40, the at least one pretreating station 70, the at least one cleaning station, the at least one UV-irradiation unit 80 and/or the at least one checking station are arranged.

In a further embodiment variant it is possible for the coating device 50 to have at least one UV-irradiation unit 80 for the UV precuring, in particular pinning, of one or more printed layers 12 of the one or more printed layers 12, and/or a UV-irradiation unit 80 for the full curing of one or more printed layers 12 of the one or more printed layers 12. The one or more printed layers 12 comprise UV adhesive and/or cold adhesive and/or adhesive and/or varnishes and/or ink. The UV-irradiation unit 80 preferably comprises a UV radiation-emitting light source which preferably emits light in the wavelength range of from 385 nm to 405 nm.

Further, it is possible for the coating device (50) to have at least one film-control unit, which examines the two or more film webs (33) for cracks in the film, film end and/or film stock, preferably by means of at least one sensor and/or by means of two or more servo motors, which are arranged on the two or more film spindles. It is in particular provided that the sensor is an optical sensor, for example a camera.

In a further design variant it is possible for the coating device 50 to have at least one movably mounted mold carrier 21, in particular a vertically or horizontally arranged rotary plate or sliding table, in particular on which the at least one holding device 20 is arranged and by means of which the at least one holding device 20, in particular together with the fixed base body 10, can be moved at least between the at least one stamping station 30 and/or the at least one printing station 40 and/or the at least one pretreating station 70 and/or the at least one checking station and/or the at least one cleaning station.

In another embodiment it is possible for the coating device 50 to have a number n stations, in particular the at least one stamping station 30, the at least one pretreating station 70, the at least one cleaning station and/or the at least one printing station 40, and for at least n holding devices 20 to be arranged on the at least one mold carrier 21.

It is in particular provided that the coating device 50 has at least one adjusting device 22 for moving the holding device 20 and/or the at least one holding device 20 arranged on the at least one common mold carrier 21 between the stations of the coating device 50.

In a further embodiment variant it is possible for the coating device 50 to have at least one process-control device 60, which actuates the adjusting device 22 in particular such that the one or more holding devices 20 are delivered cyclically in a predefined sequence to two or more stations of the coating device 50, in particular in a sequence: stamping station 30—printing station 40, printing station 40—stamping station 30, pretreating station 70—stamping station 30—printing station 40, stamping station 30—pretreating station 70—printing station 40, pretreating station 70—stamping station 30—pretreating station 70—printing station 40.

A method for coating a base body 10, in particular with a coating device 50, is shown in FIG. 4a, wherein, in the method, in particular in the following sequence, the following steps are carried out:
a) fixing the base body 10 in a holding device 20,
b) stamping one or more film elements 11 on at least one partial area of a first surface of the base body 10 and/or on at least one partial area of one or more further film elements 11 stamped on the base body 10 and/or on at least one partial area of one or more printed layers 12 applied to the base body 10, wherein the base body 10 remains in the holding device 20,
c) applying one or more printed layers 12 to at least one partial area of a first surface of the base body 10 and/or to at least one partial area of one or more film elements 11 stamped on the base body 10 and/or to at least one partial area of one or more further printed layers 12 applied to the base body 10, wherein the base body 10 remains in the holding device 20,
d) removing the coated base body 10 from the holding device 20.

It is also possible for steps b) and c) to be carried out once or multiple times and/or to be carried out in any desired order. This is also illustrated in FIG. 4b and FIG. 4c.

It is particularly preferably provided that the cycle times of steps b) and c) are in each case between 1 s and 300 s, preferably between 5 s and 120 s, in particular between 20 s and 30 s.

Further, it is possible for the method to comprise the following step, in particular wherein the step is performed before step a):
producing the base body 10 by means of injection molding and/or 3D printing and/or cutting and/or non-cutting production methods.

It is also possible for the method to comprise the following step, in particular wherein the step is performed before step a):
delivering and/or arranging the base body 10 in the holding device 20.

Furthermore, it is in particular provided that the method comprises the following step, in particular wherein the step is performed in step c):
UV irradiation, in particular pinning, by means of a UV light, preferably a UV LED, for the precuring of one or more printed layers 12 of the one or more printed layers 12, in particular UV adhesive, cold adhesive, adhesive, varnish and/or ink, in particular wherein the irradiation is carried out with light, in particular from the wavelength range of from 385 nm to 405 nm.

In an alternative embodiment variant it is provided that the method comprises the following step, in particular wherein the step is performed in step c):
UV irradiation by means of a UV light, preferably a UV LED, for the full curing of one or more printed layers 12 of the one or more printed layers 12, preferably UV adhesive, cold adhesive, adhesive, varnish and/or ink, in particular wherein the irradiation is carried out with light, in particular from the wavelength range of from 385 nm to 405 nm.

It is shown in FIG. 4b that first of all one or more printed layers 12 are applied to the base body 10 in accordance with step c) and then step b) is carried out, with the result that one or more film element 11 are stamped. It is possible for the base body 10 to be pretreated in a pretreating station 70 between the two steps b) and c), or in the reverse order.

It is in particular possible for the method to comprise the following step, in particular wherein the step is carried out once or multiple times before step b) and/or before step c):
pretreating the at least one partial area of the first surface of the base body 10 and/or the at least one partial area of the one or more film elements 11 stamped on the base body 10 and/or the at least one partial area of the one or more printed layers 12 applied to the base body 10, in particular using one or more processing methods selected from: treatment with gas, flame treatment, plasma treatment, fluorination, irradiation, cleaning, surface activation, ionization, coating.

In a further design variant it is in particular provided that, before step b) and/or step c), an optical check of the at least one partial area of the first surface of the base body 10 and/or of the at least one partial area of the one or more film elements 11 stamped on the base body 10 and/or of the at least one partial area of the one or more printed layers 12 applied to the base body 10 is effected by means of an optical sensor, in particular a camera.

In particular, it is provided that the method comprises the following step, in particular wherein the step is performed before and/or after step b), and/or before and/or after step c):
cleaning, in particular by means of brushes and/or compressed air and/or suction and/or CO₂ snow blasting and/or adhesive tape, in particular by means of pad cleaning tape and/or roll cleaning tape.

It is also possible, before and/or during and/or after step b) and/or step c), for the ingress of dust into the working space to be reduced, in particular to be prevented, by means of positive air pressure.

Further, it is expedient for the at least one mold carrier 21, on which the at least one holding device 20 is arranged, in particular together with the fixed base body 10, before step b) to be moved into a stamping position for carrying out step b) and/or before step c) to be moved into a printing position for carrying out step c).

It is also possible for the stamping of the one or more film elements 11 in step b) to be carried out by means of one or more stamping dies 32, which applies a film 33 or one or more sections of a film 33 as film elements 11 to the at least one partial area of the first surface of the base body 10 and/or the at least one partial area of the one or more further film elements 11 stamped on the base body 10 and/or to the at least one partial area of the one or more printed layers 12 applied to the base body 10.

Furthermore, it is provided that, in step b), the one or more film elements 11 of the one or more film elements 11 are stamped register-accurate relative to the one or more further film elements 11, in particular wherein one or more register marks of the optical features of the one or more further film elements 11 and/or of the holding device 20 are detected and used to control the stamping.

It is also possible for the one or more film elements 11 and/or the one or more further film elements 11 in each case to have at least one decorative layer and/or at least one functional layer, in particular a layer with an electrical functionality, in particular comprising one or more elements selected from touch sensor, antenna, electromagnetic shielding, electrically non-conductive, metallic layers for preventing electrostatic charge, display, LED, electric circuit, solar cell, at least one, in particular post-curable, protective layer and/or at least one adhesion-promoting layer.

An exemplary representation of a coating device 50 is shown in FIG. 5. The coating device 50 essentially has a stamping station 30 and a printing station 40. Further, the coating device comprises a process-control device 60, a UV-irradiation unit 80, an adjusting device 22 and a mold carrier 21. The stamping station 30 further comprises a turret 35, which carries one or more stamping dies 32, and a film feed unit 36. As indicated by the double arrow, the turret 35 is arranged displaceable in the z direction and the film feed unit 36 is arranged displaceable in the y direction by means of linear drives 23. The printing unit 41 and the UV-irradiation unit 80 are also arranged displaceable by means of linear drives 23, in particular arranged displaceable in the z direction, as likewise indicated by the double arrow. The printing unit 41 and the UV-irradiation unit 80 are described in more detail below. Furthermore, it is in particular provided that the mold carrier 21 and the adjusting device 22 are also arranged displaceable by means of linear drives 23. These are likewise described in detail below.

Essentially, the mold carrier 21 can be moved in the y direction between the stamping station 30, the printing station 40 and the UV-irradiation unit, for this the adjusting device 22 is actuated by means of the process-control device 60, with the result that the mold carrier 21 can be moved between a stamping position and a printing position. Furthermore, it is provided that the mold carrier 21 is brought into the stamping position for stamping one or more film elements 11 and, analogously thereto, is brought into the printing position for applying one or more printed layers 12. The process-control device 60 then controls the stamping process and/or the printing process. Individual decorations can be effected by means of the film feed unit 36, the turret 35 and the printing unit 41 which are movable via linear drives 23.

FIG. 6 shows an exemplary representation of the adjusting device 22 and the mold carrier 21. The mold carrier 21 can be moved along the y direction by means of a linear drive 23, which is arranged on the adjusting device 22. The mold carrier 21 itself has a further linear drive 23, which allows the mold carrier 21 to move in the x direction. The movement directions are in particular illustrated by the two double arrows.

An exemplary representation of the printing unit 41 is shown in FIG. 7. In this embodiment variant, the printing unit 41 comprises four printheads 42. These can cover the color space of the CMYK color model, for example. However, it is also possible for colors of the RGB color model, transparent printing ink, in particular clear varnish and/or protective varnish (ClearCoat), and/or adhesive, in particular cold adhesive and/or UV adhesive, and/or varnishes to be applied by means of the printheads 42. In this exemplary variant, each of the four printheads 42 has a UV-irradiation unit 80, in particular for the precuring of one or more printed layers 12 of the one or more printed layers 12. However, it is also possible for the UV-irradiation unit 80 to be implemented for the full curing of one or more printed layers 12 of the one or more printed layers 12.

Furthermore, it is preferably provided that the printing unit 41 is movable together with the four printheads 42 in the x direction by means of a linear drive 23, as indicated by the double arrow. In addition, it is possible for each of the printheads 42 to have its own linear drive 23 for individually moving the printheads 42 along the z axis, as indicated by the double arrow. In this case, the arrangement of the linear drives 23 is not intended to have a limitative effect. Furthermore, it is possible for the printing unit 41 and/or the printheads 42 to have further linear drives 23, which allow the printing unit 41 and/or the printheads 42 to move in further spatial directions.

An exemplary UV-irradiation unit 80 is represented in FIG. 8. This is preferably a UV-irradiation unit 80 for the full curing of one or more printed layers of the one or more printed layers 12. However, it is also possible for the UV-irradiation unit 80 to be a UV-irradiation unit 80 for the precuring of one or more printed layers 12 of the one or more printed layers 12.

In this alternative design, the UV-irradiation unit 80 has a linear drive 23, whereby the UV-irradiation unit 80 can be moved in the z direction. However, it is also possible for the UV-irradiation unit 80 to comprise further linear drives 23, with the result that the UV-irradiation unit 80 can be moved in further and/or other spatial directions.

A base body 10 is represented by way of example in FIG. 9a. The base body 10 shown is a vehicle part, in particular a cockpit component. It is possible for the geometry of the base body 10 to have individual shapes, with the result that it has in particular uneven and/or curved surfaces.

Because of the varied geometry of the base body 10, holding devices 20 matched to the base body 10 are necessary in most cases. Such an exemplary holding device 20 is represented in FIG. 9b. The holding device 20 preferably fixes the base body 10 in a positive-locking and/or a non-positive-locking manner, with the result that it is held positionally accurately during the further processing. This in particular offers the advantage that the further method steps can also be carried out positionally accurately and/or register-accurately. Here, it is preferably also possible for the holding device 20 to have position marking and/or register marking, which are detected by a recognition unit, and then a positionally accurate stamping of one or more film elements 11 and/or application of one or more printed layers 12 is effected.

### LIST OF REFERENCE NUMBERS

10 base body
11 film element
12 printed layer
20 holding device
21 mold carrier
22 adjusting device
23 linear drive
30 stamping station
31 stamping unit
32 stamping die
33 film/film web
34 film spindle
35 turret
36 film feed unit
40 printing station
41 printing unit
42 printhead
50 coating device
60 process-control device
70 pretreating station
80 UV-irradiation unit

1. A coating device for coating a base body,
the coating device comprising at least one holding device for fixing a base body, at least one stamping station and at least one printing station for applying one or more printed layers to at least one partial area of a first surface of the base body and/or to at least one partial area of one or more film elements stamped on the base body and/or to at least one partial area of one or more further printed layers applied to the base body, and wherein the stamping station has one or more stamping units for stamping one or more film elements on at least one partial area of a first surface of the base body and/or on at least one partial area of one or more further film elements stamped on the base body and/or on at least one partial area of one or more printed layers applied to the base body.

2. The coating device according to claim 1, wherein
the base body is a rigid body.

3. The coating device according to claim 1, wherein
the base body comprises a component, an injection-molded part, a 3D-printed part and/or a component produced by means of cutting and/or non-cutting production methods.

4. (canceled)

5. The coating device according to claim 1, further comprising
at least one checking station for optically checking at least one partial area of the surface of the base body, the one or more film elements stamped on the base body and/or the one or more printed layers applied to the base body by means of an optical sensor.

6-7. (canceled)

8. The coating device according to claim 1, further comprising
at least one movably mounted mold carrier and by means of which the at least one holding device, can be moved at least between the at least one stamping station and/or the at least one printing station and/or at least one pretreating station and/or at least one checking station and/or at least one cleaning station.

9. The coating device according to claim 8, wherein
the coating device has a number n stations, and wherein at least n holding devices are arranged on the at least one mold carrier.

10. The coating device according to claim 1, wherein
the stamping station has at least one turret wherein the turret comprises one or more stamping die receivers which receive one or more stamping dies.

11. The coating device according to claim 10, wherein
the one or more stamping dies are replaceably mounted on the one or more stamping die receivers of the at least one turret.

12. The coating device according to claim 10, wherein
the one or more stamping die receivers and the one or more stamping dies are encoded.

13. The coating device according to claim 10, wherein
the one or more stamping dies each have at least one direct heater for rapidly heating the stamping die.

14. The coating device according to claim 10, wherein
the one or more stamping dies not mounted on the turret are temporarily mounted in a bracket of the coating device for preheating.

15-16. (canceled)

17. The coating device according to claim 1, wherein
the stamping station has at least one film feed unit, wherein the film feed unit comprises two or more film spindles which wind and unwind two or more film webs.

18. The coating device according to claim 17, wherein
the at least one film feed unit has at least one splicing aid and/or wherein the two or more film spindles can be removed.

19. The coating device according to claim 1, wherein
the coating device has at least one film-control unit which examines the two or more film webs for cracks in the film, film end and/or film stock.

20. (canceled)

21. The coating device according to claim 1, wherein
the at least one printing station comprises at least one printing unit.

22. (canceled)

23. The coating device according to claim 1, wherein
the at least one printing station comprises a digital printing station and/or an inkjet printing station and/or a pad printing station and/or an inkjet printing station.

24. The coating device according to claim 8, wherein
the coating device has at least one adjusting device for moving the holding device and/or the at least one holding device arranged on the at least one common mold carrier between the stations of the coating device.

25. The coating device according to claim 24, wherein
the coating device has at least one process-control device, which actuates the adjusting device.

26. A method for coating a base body wherein, in the method, the following steps are carried out:
a) fixing the base body in a holding device,
b) stamping one or more film elements on at least one partial area of a first surface of the base body and/or on at least one partial area of one or more further film elements stamped on the base body and/or on at least one partial area of one or more printed layers applied to the base body, wherein the base body remains in the holding device,
c) applying one or more printed layers to at least one partial area of a first surface of the base body and/or to at least one partial area of one or more film elements stamped on the base body and/or to at least one partial area of one or more further printed layers applied to the base body, wherein the base body remains in the holding device,
d) removing the coated base body from the holding device.

27. The method according to claim 26, wherein
steps b) and c) are carried out once or multiple times and/or are carried out in any desired order.

28. The method according to claim 26, wherein
the cycle times of steps b) and c) are in each case between 1 s and 300 s.

29-31. (canceled)

32. The method according to claim 26, wherein
the application of the one or more printed layers is carried out by means of digital printing and/or inkjet printing and/or inkjet printing and/or pad printing.

33-35. (canceled)

36. The method according to claim 26, wherein,
before step b) and/or step c), an optical check of the at least one partial area of the first surface of the base body and/or of the at least one partial area of the one or more film elements stamped on the base body and/or of the at least one partial area of the one or more printed layers applied to the base body is effected by means of an optical sensor.

37. The method according to claim 26, wherein
the method comprises the following step:
cleaning.

38. The method according to claim 26, wherein,
before and/or during and/or after step b) and/or step c), the ingress of dust into the working space is reduced, by means of positive air pressure.

39-40. (canceled)

41. The method according to claim 26, wherein
the stamping of the one or more film elements in step b) is carried out by means of one or more stamping dies, which applies a film or one or more sections of a film as film elements to the at least one partial area of the first surface of the base body and/or the at least one partial area of the one or more further film elements stamped on the base body and/or to the at least one partial area of the one or more printed layers applied to the base body.

42. The method according to claim 26, wherein
a hot-stamping film comprising a carrier ply and a transfer ply detachable therefrom is used as film in step b) and/or, during step b), at least one section of the transfer ply determined by the shape of the stamping die is applied as film element by activating an adhesive layer of the transfer ply or an adhesive layer provided between the base body and the transfer ply.

43. The method according to claim 26, wherein
a transfer film, comprising a carrier ply and a transfer ply detachable therefrom is used as film in step b), which an adhesive layer, is applied, to the transfer ply and/or to a partial area of the surface of the base body in a first area, but is not applied in a second area, the transfer film is guided towards the surface of the base body, the adhesive layer is activated and the transfer film is peeled off again, with the result that a section of the transfer ply determined by the shape of the first area is applied as film element.

44. The method according to claim 26, wherein
a laminating film is used as film in step b) and, during the stamping, at least one section of the laminating film determined by the shape of the stamping die is applied as film element by activating an adhesive layer of the laminating film or an adhesive layer provided between the surface of the base body and the laminating film.

45. (canceled)

46. The method according to claim 26, wherein
the one or more film elements and/or the one or more further film elements in each case have at least one decorative layer and/or at least one functional layer.

47. (canceled)
